(19) United States
(12) Patent Application Publication
(10) Pub. No.: US 2009/0278655 A1
(43) Pub. Date: Nov. 12, 2009

(54) Method for inhibiting egress from a chamber containing contaminants

(75) Inventors: Isaac Secemski, Teaneck, NJ (US); Benjamin Gottesman, New York, NY (US); Mickey Reiss, New York, NY (US); Eli Grossman, Teaneck, NJ (US)

Correspondence Address: AMSTER, ROTHSTEIN & EBENSTEIN LLP, 90 PARK AVENUE, NEW YORK, NY, 10016, US

(73) Assignee: The Abraham Joshua Heschel School

(21) Appl. No.: 12/151,305

(22) Filed: May 6, 2008

(51) Int. Cl. G05B 19/00

(52) U.S. Cl. 340/5.52

(57) ABSTRACT

An embodiment of the present invention comprises a method of securing a room from removal of contaminants from the room, comprising a chamber and a portal with a door, wherein the method comprises: locking the door of the portal of the room; electronically sensing flesh of a hand of an occupant with a detecting device to determine if the flesh is exposed; automatically unlocking the door of the portal in response to electronically sensing the flesh in contact with the detecting device.

### NO GOVERNMENT LICENSE RIGHTS

No federal government funding was used to develop the present invention. Rather, the present invention was conceived as part of a high school class project at the Abraham Joshua Heschel School in New York City, N.Y.

### FIELD OF INVENTION

The present invention relates to a method of inhibiting individuals who are wearing hand protection from leaving a chamber containing contaminants prior to removing the hand protection.

### BACKGROUND OF THE INVENTION

In many locations, such as in hospitals and in biological and chemical laboratories, materials of various degrees of hazardous classification are handled. Depending on the level of the hazard, OSHA regulations require individuals to protect themselves when handling the hazardous material. Such regulations are described in the OSHA Occupational Safety and Health Standards, Standard Number 1910.138 (Personal Protective Equipment: Hand Protection). This information is available at http://www.osha.gov/pls/oshaweb/owadisp.show_document?p_table=STANDARDS&p_id=9788. This level of protection depends on the nature of the material being handled. Typically, for materials as delineated in the OSHA classification of toxic and hazardous substances, Standard 1910, subpart Z applies. This information is available at http://www.osha.gov/SLTC/versonalprotectiveeguipment/standards.html. It mandates covering the body with a lab coat and covering the hands with some sort of protective glove made of either rubber, latex, or a similar type of material. Wearing of safety glasses, a mask, or full face protection may also be necessary.

Even when not mandated, it is considered good practice to remove all potentially contaminated garments prior to leaving the chamber that contains the hazardous material so as to prevent contamination outside of the chamber. This is especially important for hand coverings since the hands are much more likely to come into contact with common areas such as door handles, faucets, handrails and the like. However, given the inconvenience of removing rubber or latex gloves every time an individual leaves a chamber containing contaminants, and then putting on another pair when returning, it is common practice for individuals not to remove gloves when leaving such chambers for a short period of time prior to returning to the same area. This also applies if an individual has to pass through an unrestricted area when moving from one chamber to another.

Accordingly, there is a long felt need for a system that inhibits an individual from leaving a chamber containing contaminants while still wearing hand protection such as a rubber or latex glove. In order to leave the chamber, the individual must remove at least one and, depending on the system in place, possibly both gloves, prior to gaining access to leave the chamber.

### SUMMARY OF THE INVENTION

According to an exemplary embodiment of the present invention, a method of securing a room from removal of contaminants from the room, comprising a chamber and a portal with a door, wherein the method comprises: locking the door of the portal of the room; electronically sensing flesh of a hand of an occupant with a detecting device to determine if the flesh is exposed; and automatically unlocking the door of the portal in response to electronically sensing the flesh in contact with the detecting device.

In at least one embodiment, the step of electronically sensing further comprises electronically sensing at least one hand.

In at least one embodiment, the step of electronically sensing at least one hand requires sensing the flesh of at least one finger tip of the hand.

In at least one embodiment, the step of electronically sensing at least one hand requires sensing the flesh of five fingertips of the hand.

In at least one embodiment, the step of electronically sensing further comprises electronically sensing two hands of the occupant to determine if flesh is exposed in both hands.

In at least one embodiment, the step of electronically sensing two hands requires sensing the flesh of at least one finger tip on each hand.

In at least one embodiment, the step of electronically sensing two hands requires sensing the flesh of five finger tips on each hand.

In at least one embodiment, the step of electronically sensing is performed by measuring the capacitance between the hand and a sensor.

In at least one embodiment, the step of electronically sensing the hand requires sensing the flesh of five finger tips of the hand.

In at least one embodiment, the door has a lock which is electronically triggered.

In at least one embodiment, a receptacle intended for glove disposal is provided.

In at least one embodiment, an emergency over-ride system is present that allows unrestricted egress in times in times of emergency.

### BRIEF DESCRIPTION OF THE DRAWINGS

The above and related objects, features and advantages of the present invention will be more fully understood by reference to the following, detailed description of an embodiment of the present invention when taken in conjunction with the accompanying figures, wherein:

FIG. 1 is a schematic front view of an egress inhibitor of an embodiment of the present invention;

FIG. 2 is a schematic front view of an egress inhibitor of an embodiment of the present invention;

FIG. 3 is a schematic front view of an egress inhibitor of an embodiment of the present invention;

FIG. 4 is a schematic front view of an egress inhibitor of an embodiment of the present invention;

FIG. 5 is a schematic front view of an egress inhibitor of an embodiment of the present invention;

FIG. 6 is a schematic front view of an egress inhibitor of an embodiment of the present invention;

FIG. 7 is a schematic front view of an egress inhibitor of an embodiment of the present invention;

FIG. 8 is a schematic front view of an egress inhibitor of an embodiment of the present invention; and

FIG. 9 is a detailed schematic front view of a glove discard receptacle of an embodiment of the present invention.

### DETAILED DESCRIPTION OF THE PRESENT INVENTION

The following is a description of various embodiments of the present invention. Although the intention is not to narrowly limit the present invention to the exact specifics described herein but to cover systems-that lie within the spirit and scope of the invention.

The present invention relates to individuals who are wearing hand protection (e.g., gloves) that may be contaminated with hazardous material. The present invention inhibits individuals who are wearing such hand protection from leaving chambers containing contaminants and entering common areas which are assumed to be essentially free from such hazardous material. This is achieved via a system that is activated by contact with bare flesh of the hand or fingers and only allows egress for individuals whose hand or hands are not covered with protective gloves.

Exemplary embodiments of the present invention are hereto described by references to the Figures.

According to an exemplary embodiment of the present invention, there is provided a system, within the confines of the chamber and in close proximity to the exit door, that can identify bare skin. In order for an individual to open the door to exit the chamber, he/she must activate a system that can distinguish between a bare hand and a gloved hand. Thus, in order to activate the system that opens the door, the individual must remove a glove or both gloves, depending on the type of system in operation.

While systems that limit access to entering a room are well known, a system used to limit egress from an area until the contaminated gloves have been removed, is heretofore unknown to the inventors.

Examples of systems that can be used with the present invention are described in U.S. Pat. No. 4,353,056, by Tsikos, and U.S. Pat. No. 5,903,225, by Schmitt, et al. One such system, described in U.S. Pat. No. 4,353,056, by Tsikos, involves recognition of non-specific skin by virtue of the conductivity of the skin as compared to non-living material. A second type of system, described in U.S. Pat. No. 5,903,225, by Schmitt, et al, involves an integrated circuit fingerprint sensor. These systems, or similar systems that achieve the same purpose, would be useful in the present invention in that a glove must be removed in order to activate the system.

A system that forces the individual to remove one glove, especially from the favored hand, will be useful in that the favored hand is typically used to open door handles, turn faucets and the like. Thus, removal of the glove from the favored hand will limit cross-contamination.

However, to ensure removal of both gloves will entail a system that requires activation of two sensor systems essentially simultaneously.

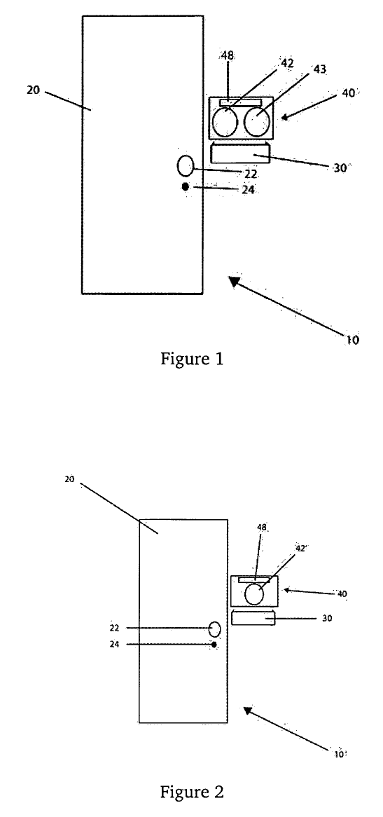

FIG. 1 represents an exemplary embodiment of the present invention. In particular, FIG. 1 is a schematic front view of the egress inhibitor (10), comprised of a door (20) having a knob (22), and an electronically triggered lock (24); a glove discard receptacle (30); and a wall-mounted control panel unit (40) having a left hand sensor (42), a right hand sensor (43), and a visual feedback unit (48).

In this embodiment, opening the lock of the door is triggered by the individual placing both bare hands on two wall-mounted sensors. Upon recognition of two hands placed simultaneously on the sensors, the door is unlocked and allows egress. This example represents a stringent system because it requires both hands to be glove-free before granting egress.

FIG. 2 represents another exemplary embodiment of the present invention. FIG. 2 is a schematic front view of the egress inhibitor (10′), comprised of a door (20) having a knob (22), and an electronically triggered lock (24); a glove discard receptacle (30); and a wall-mounted control panel unit (40) having a hand sensor (42′) and a visual feedback unit (48).

In this embodiment, a less stringent system is disclosed which grants egress upon confirmation that one of the hands is glove-free.

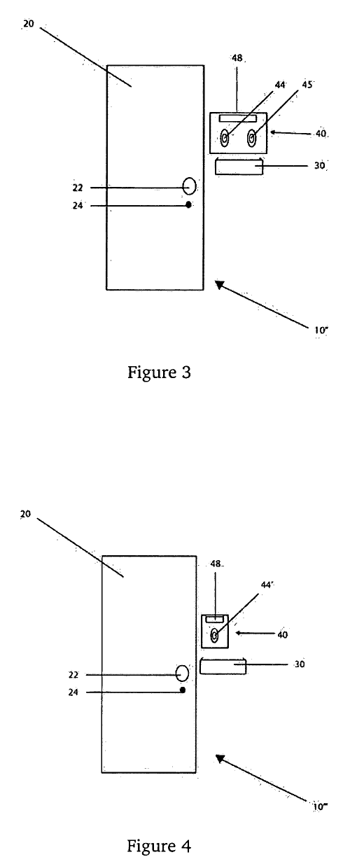

FIG. 3 represents another exemplary embodiment of the present invention in which a system is disclosed that is triggered on the basis of recognition of bare fingers. FIG. 3 is a schematic front view of the egress inhibitor (10″), comprised of a door (20) having a knob (22), and an electronically triggered lock (24); a glove discard receptacle (30); and a wall-mounted control panel unit (40) having a left finger sensor (44), a right finger sensor (45), and a visual feedback unit (48).

Two sensors (44, 45) are used in which activation occurs when they both simultaneously sense one finger. The distance between the sensors should be such that both sensors cannot be activated by two fingers of the same hand. This guarantees that the gloves on both hands must be removed before egress is granted. These sensors do not need to make a distinction between fingers, since individuals would vary which finger they use to activate such a system.

FIG. 4 is a schematic front view of the egress inhibitor (10′″), comprised of a door (20) having a knob (22), and an electronically triggered lock (24); a glove discard receptacle (30); and a wall-mounted control panel unit (40) having a finger sensor (44′) and visual feedback unit (48).

FIG. 4 represents a less stringent variation of the finger recognition system in that recognition of a finger on only one hand is necessary to trigger unlocking of the door. In the systems that recognize a bare finger, the sensor can be based on a fingerprint recognition system. However, this typically would not be required since it should be sufficient to recognize that flesh is exposed without determining the individual who is seeking to egress the chamber.

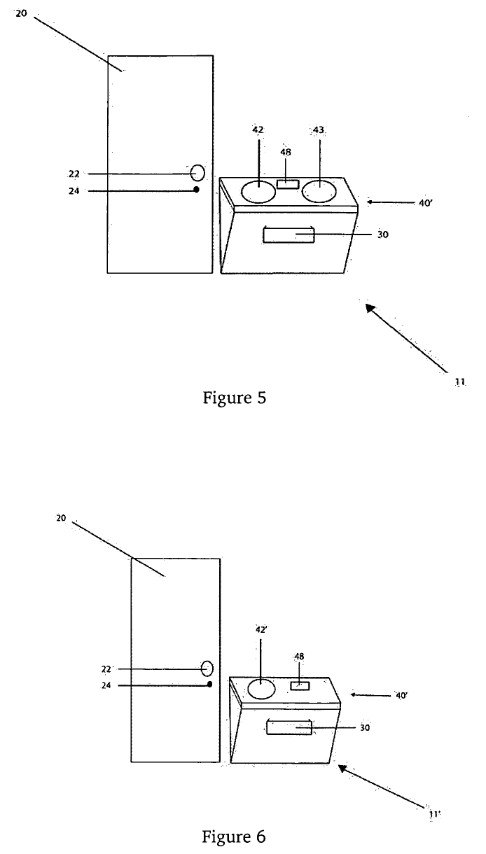

FIGS. 5, 6, 7 and 8 all represent hand or finger recognition systems in which the sensors are positioned such that the individual requiring egress places the hand or finger on sensors positioned horizontally.

FIG. 5 is a schematic front view of the egress inhibitor (11), comprised of a door (20) having a knob (22), and an electronically triggered lock (24); a glove discard receptacle (30); and a control panel unit (40′) having a left hand sensor (42), a right hand sensor (43), and visual feedback unit (48).

FIG. 6 is a schematic front view of the egress inhibitor (11′), comprised of a door (20) having a knob (22), and an electronically triggered lock (24); a glove discard receptacle (30); and a control panel unit (40′) having a hand sensor (42′) and a visual feedback unit (48).

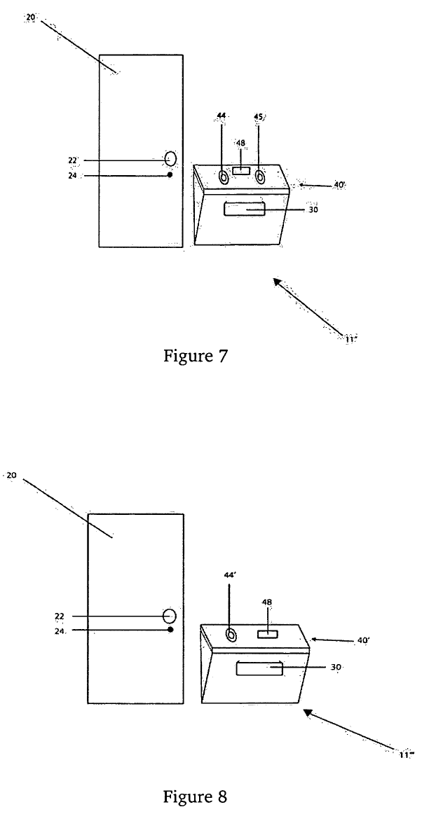

FIG. 7 is a schematic front view of the egress inhibitor (11″), comprised of a door (20) having a knob (22), and an electronically triggered lock (24); a glove discard receptacle (30); and a control panel unit (40′) having a left finger sensor (44), a right finger sensor (45), and visual feedback unit (48).

FIG. 8 is a schematic front view of the egress inhibitor (11′″), comprised of a door (20) having a knob (22), and an electronically triggered lock (24); a glove discard receptacle (30); and a control panel unit (40′) having a finger sensor (44′) and visual feedback unit (48).

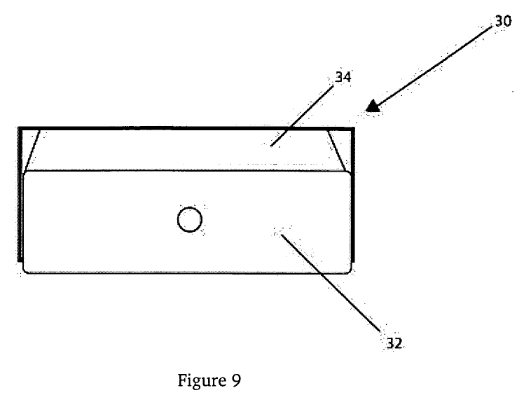

In one embodiment of the present invention a glove discard receptacle can be used in conjunction with the egress inhibitor of the present invention. FIG. 9 is a detailed schematic front view of an exemplary glove discard receptacle (30), comprised of a removable drawer (32), and its storage compartment (34).

In any of the embodiments of the present invention, the systems may also include an emergency over-ride system that allows unrestricted exit in times of emergency.

Now that various embodiments of the present invention have been shown and described in detail, various modifications and improvements thereon will become readily apparent to those skilled in the art. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed:

1. A method of securing a room from removal of contaminants from the room, comprising a chamber and a portal with a door, wherein the method comprises:
(a) locking the door of the portal of the room;
(b) electronically sensing flesh of a hand of an occupant with a detecting device to determine if the flesh is exposed;
(c) automatically unlocking the door of the portal in response to electronically sensing the flesh in contact with the detecting device.

2. The method of claim 1, wherein the step of electronically sensing further comprises electronically sensing at least one hand.

3. The method of claim 2, wherein the step of electronically sensing at least one hand requires sensing the flesh of at least one finger tip of the hand.

4. The method of claim 3 wherein the step of electronically sensing at least one hand requires sensing the flesh of five fingertips of the hand.

5. The method of claim 1, wherein the step of electronically sensing further comprises electronically sensing two hands of the occupant to determine if flesh is exposed in both hands.

6. The method of claim 5, wherein the step of electronically sensing two hands requires sensing the flesh of at least one finger tip on each hand.

7. The method of claim 6, wherein the step of electronically sensing two hands requires sensing the flesh of five finger tips on each hand.

8. The method of claim 1, wherein the step of electronically sensing is performed by measuring the capacitance between the hand and a sensor.

9. The method of claim 1, wherein the step of electronically sensing the hand requires sensing the flesh of five finger tips of the hand.

10. The method of claim 1, wherein the door has a lock which is electronically triggered.

11. The method of claim 1, wherein a receptacle intended for glove disposal is provided.

12. The method of claim 1, wherein an emergency over-ride system is present that allows unrestricted egress in times in times of emergency.
